(19) United States
(12) Patent Application Publication
(10) Pub. No.: US 2023/0312942 A1
(43) Pub. Date: Oct. 5, 2023

(54) COATING SOLUTION, GLASS SHEET, AND LAMINATED GLASS FOR BLOCKING UV AND BLUE LIGHT

(71) Applicant: FUYAO GLASS INDUSTRY GROUP CO., LTD., Fuqing (CN)

(72) Inventors: Qirui PANG, Fuqing (CN); Shanji GUO, Fuqing (CN); Yingying SUN, Fuqing (CN); Canzhong ZHANG, Fuqing (CN); Cheng KE, Fuqing (CN)

(73) Assignee: FUYAO GLASS INDUSTRY GROUP CO., LTD., Fuqing (CN)

(21) Appl. No.: 18/206,372

(22) Filed: Jun. 6, 2023

Related U.S. Application Data
(63) Continuation of application No. PCT/CN2021/137433, filed on Dec. 13, 2021.

(30) Foreign Application Priority Data
Dec. 15, 2020 (CN) 202011469860.1

(51) Int. Cl. C09D 5/32; C09D 1/00; C09D 7/63; C09D 7/20; C09D 7/41; C09J 1/00; G02B 5/20; B32B 17/10; C03C 17/00

(52) U.S. Cl. CPC C09D 5/32; C09D 1/00; C09D 7/63; C09D 7/20; C09D 7/41; C09J 1/00; G02B 5/208; B32B 17/10036; C03C 17/009; B32B 17/10541; B32B 2250/40; B32B 17/10761; B32B 2605/006; C03C 2217/74; C03C 2218/11

(57) ABSTRACT

A coating solution for blocking ultraviolet (UV) and blue light includes a silica sol and a chelating agent. The silica sol includes silicate, a first solvent, a first coupling agent, a first catalyst, and deionized water. The chelating agent includes a UV absorber, a blue-light absorber, a second solvent, a second catalyst, and a second coupling agent. A glass sheet for blocking UV and blue light includes a bent glass panel (1) and a coating (2) for blocking UV and blue light. A laminated glass for blocking UV and blue light includes a glass sheet for blocking UV and blue light, an intermediate adhesive layer, and a second glass panel.

### CROSS-REFERENCE TO RELATED APPLICATION(S)

This application is a continuation of International Application No. PCT/CN2021/137433, filed Dec. 13, 2021, which claims priority to Chinese Patent Application No. 202011469860.1, filed Dec. 15, 2020, the disclosures of which are hereby incorporated by reference in their entireties.

### TECHNICAL FIELD

This disclosure relates to the field of surface coating technology, and particularly to a functional coating that can be coated on a surface of a glass sheet. Specifically, in the disclosure, a coating solution for blocking ultraviolet (UV) and blue light, a glass sheet for blocking UV and blue light, and a laminated glass for blocking UV and blue light are provided, and a laminated glass for blocking UV and blue light and capable of dimming or light emitting is further provided.

### BACKGROUND

A functional coating can be formed on a surface of a substrate by means of surface coating technology, so as to satisfy requirements such as infrared blocking, ultraviolet (UV) blocking, hydrophobic property and oleophobic property, and fog resistance. A UV-blocking coating can significantly reduce a transmittance of UV rays, thereby reducing harm caused by UV rays to human health, and preventing interior decorations of vehicles and houses from aging and fading in a short period. There has been a relatively mature technology for forming a UV-blocking coating on a surface of a glass substrate. For example, Japanese Patent Applications No. 2009184882A, No. 2013189345A, and Chinese Patent Applications No. 102892851A, No. 103347833A, and No. 111819160A, etc., disclose a technology for forming a UV-blocking coating on a surface of a glass substrate by coating a UV-blocking coating solution, the glass substrate with the UV-blocking coating whereby has a relatively good UV-blocking capability and relatively high mechanical durability in hardness and abrasion resistance, etc.

In a visible spectrum, light in a wavelength range of 400 nm˜500 nm is generally defined as blue light, where short-wave blue light in a wavelength range of 400 nm˜420 nm has relatively high energy that may be harmful to a retina and cause visual fatigue, dazzle, maculopathy, etc. Therefore, a transmittance of the short-wave blue light also needs to be reduced. Chinese Patent Application No. 109455945A discloses a reflective blue-light blocking glass sheet and a method for manufacturing the glass sheet. The glass sheet includes a glass substrate and a blue-light blocking coating. The blue-light blocking coating is formed from a coating solution that has a reflection function, and the coating has a reflectivity of 50% for blue-light in a wavelength range of 400 nm˜450 nm. The blue-light blocking coating is mainly coated to electronic products due to its failure in meeting performance requirements of a surface coating on a vehicle glass in terms of abrasion resistance.

In addition, Chinese Patent Application No. 111201457A discloses a glass structure. The glass structure includes a pair of glass sheets, a dimmer disposed between the pair of glass sheets, and a UV absorbing layer disposed between the dimmer and one glass sheet. The UV absorbing layer has a maximum transmittance of less than or equal to 10% over a wavelength range of 370 nm˜400 nm, a maximum transmittance of greater than or equal to 50% over a wavelength range of 400 nm˜420 nm. If the maximum transmittance over the wavelength range of 400 nm˜420 nm is less than 50%, the glass structure looks colored when irradiated by sunlight.

### SUMMARY

A coating solution for blocking UV and blue light is configured to form a coating for blocking UV and blue light on a surface of a substrate, and includes a silica sol and a chelating agent. The silica sol includes, in mass percent, silicate of 15%˜35%, a first solvent of 30%˜60%, a first coupling agent of 5%˜15%, a first catalyst of 0.01%˜1%, and deionized water of 10%˜30%. The chelating agent includes, in mass percent, a UV absorber of 1%˜15%, a blue-light absorber of 1%˜15%, a second solvent of 40%˜60%, a second catalyst of 0.01%˜1%, and a second coupling agent of 10%˜30%.

A glass sheet for blocking UV and blue light is provided in the disclosure. The glass sheet includes a bent glass panel and a coating for blocking UV and blue light. The coating is disposed on at least one surface of the bent glass panel. The coating includes silica, a UV absorber, and a blue-light absorber, the coating has a thickness ranging from 2 μm˜12 μm, the coating has a transmittance less than or equal to 5% over a wavelength range of 300 nm˜400 nm, and the coating has a maximum transmittance less than or equal to 30% over a wavelength range of 400 nm˜440 nm.

A laminated glass for blocking UV and blue light is provided in the disclosure. The laminated glass includes the glass sheet, an intermediate adhesive layer, and a second glass panel. The intermediate adhesive layer is sandwiched between the glass sheet and the second glass panel. The glass sheet includes the bent glass panel and the coating. The coating is disposed on at least one surface of the bent glass panel. The coating is located between the bent glass panel and the intermediate adhesive layer.

A laminated glass for blocking UV and blue light and capable of dimming or light emitting is further provided. The laminated glass includes a first glass panel, a first adhesive layer, a dimming structure or a light emitting structure, a second adhesive layer, and a second glass panel that are stacked in sequence. A coating for blocking UV and blue light is disposed between the first glass panel and the dimming structure or between the first glass panel and the light emitting structure, where the coating includes silica, a UV absorber, and a blue-light absorber, the coating has a transmittance less than or equal to 5% over a wavelength range of 300 nm˜400 nm, and the coating has a maximum transmittance less than 30% over a wavelength range of 400 nm˜440 nm; and/or the coating for blocking UV and blue light is disposed between the second glass panel and the dimming structure or between the second glass panel and the light emitting structure, where the coating includes silica, a UV absorber, and a blue-light absorber, the coating has a transmittance less than or equal to 5% over a wavelength range of 300 nm˜400 nm, and the coating has a maximum transmittance less than or equal to 30% over a wavelength range of 400 nm˜440 nm.

### BRIEF DESCRIPTION OF THE DRAWINGS

FIG. 1 is a schematic structural diagram of a glass sheet for blocking ultraviolet (UV) and blue light provided in the disclosure.

FIG. 2 is a schematic structural diagram of a laminated glass for blocking UV and blue light provided in the disclosure.

FIG. 3 is a schematic structural diagram of a laminated glass for blocking UV and blue light provided in the disclosure, where the laminated glass is provided with a dimming structure.

FIG. 4 is a another schematic structural diagram of a laminated glass for blocking UV and blue light provided in the disclosure, where the laminated glass is provided with a dimming structure.

### DETAILED DESCRIPTION

The disclosure is described in detail with combination of accompanying drawings as follows.

In order to solve a technical problem that a blue-light blocking coating or an ultraviolet (UV) absorbing layer in the related art cannot block both UV and blue light, in the disclosure, a coating solution for blocking UV and blue light, a glass sheet for blocking UV and blue light coated with the coating solution, and a method for manufacturing the glass sheet are provided, and a laminated glass for blocking UV and blue light and capable of dimming or light emitting is further provided.

A coating solution for blocking ultraviolet (UV) and blue light is provided in the disclosure. The coating solution is configured to form a coating for blocking UV and blue light on a surface of a substrate. The coating can absorb UV and blue light to reduce a UV transmittance and a blue-light transmittance. The coating includes a silica sol and a chelating agent. The silica sol is added with the chelating agent of 5%˜20% in mass percent. In some embodiments, a mass percentage of chelating agent to silica sol ranges from 5% to 20%.

The silica sol includes, in mass percent, silicate of 15%˜35%, a first solvent of 30%˜60%, a first coupling agent of 5%˜15%, a first catalyst of 0.01%˜1%, and deionized water of 10%˜30%. The silica sol can be obtained by mixing and stirring the following components in mass percent: the silicate of 15%˜35%, the first solvent of 30%˜60%, the first coupling agent of 5%˜15%, the first catalyst of 0.01%˜1%, and the deionized water of 10%˜30%.

The chelating agent includes, in mass percent, a UV absorber of 1%˜15%, a blue-light absorber of 1%˜15%, a second solvent of 40%˜60%, a second catalyst of 0.01%˜1%, and a second coupling agent of 10%˜30%. The chelating agent can be obtained by mixing and stirring the following components in mass percent: the UV absorber of 1%˜15%, the blue-light absorber of 1%˜15%, the second solvent of 40%˜60%, the second catalyst of 0.01%˜1%, and the second coupling agent of 10%˜30%.

By adding the blue-light absorber, the coating solution can reduce both the UV transmittance and the blue-light transmittance, such that the coating for blocking both UV and blue light is obtained. In addition, the coating also has excellent properties such as aging resistance and abrasion resistance, such that a normal service life of the substrate of the coating can be prolonged. Additionally, the coating solution has a very low volatile organic compound (VOC) emission, which is environmentally friendly and easy to coat. The coating can also comply with regulations of vehicle glass.

In the disclosure, the silicate is selected from a group consisting of tetramethyl orthosilicate, tetraethyl orthosilicate, trimethoxysilane, triethoxysilane, and dimethyldimethoxysilane.

Each of the first coupling agent and the second coupling agent is a silane coupling agent, and is selected from a group consisting of 3-Aminopropyltrimethoxysilane (KH540), γ-Aminopropyltriethoxysilane (KH550), γ-(2,3-Epoxypropoxy)propyltrimethoxysilane (KH560), γ-Methacryloxypropyltrimethoxysilane (KH570), and N-(β-Aminoethyl)-γ-aminopropyltrimethoxysilane (KH792). It can be understood that the first coupling agent and the second coupling agent may be the same silane coupling agent or different silane coupling agents.

Considering factors such as coating uniformity and performance, in some embodiments, the first solvent is at least one of methanol, ethanol, propanol, isopropanol, butanol, or propylene glycol methyl ether, and the second solvent is at least one of butyl acetate, propylene glycol methyl ether, isobutyl acetate, or xylene.

Additionally, in view of coating formation time and the effect, etc., in some embodiments, the first catalyst is at least one of hydrochloric acid, nitric acid, or ammonia solution, and the second catalyst is at least one of dibutyltin dilaurate (DY-12), an organobismuth catalyst (DY-20), or stannous octoate.

In some embodiments, the UV absorber has an absorption peak in a wavelength range of 330 nm˜370 nm, and is selected from a group consisting of a benzophenone UV absorber, a benzimidazole UV absorber, and a triazine UV absorber. Considering factors such as the coating uniformity and performance, in some embodiments, a hydroxyl content of the UV absorber is greater than or equal to 5% in mass percent.

Specifically, the benzophenone UV absorber mentioned above may be 2,4-Dihydroxybenzophenone, 2,2′,3(or any of 4, 5 and 6)-Trihydroxybenzophenone, 2,2′,4,4′-tetrahydroxybenzophenone, 2,4-Dihydroxy-2′,4′-Dimethoxybenzophenone, 2-Hydroxy-4-Octyloxybenzophenone, etc.

Specifically, the benzimidazole UV absorber mentioned above may be 2-(2H-benzotriazol-2-yl)-4,6-bis(1-methyl-1-phenylethyl)phenol (UV absorber, trade name UV-234), 2-(5-chloro-2H-benzotriazol-2-yl)-4-methyl-6-(tert-butyl)phenol, octyl-3-[3-tert-butyl-4-hydroxy-5-[5-chloro-2H-benzotriazol-2-yl]propionate, 2-(2H-benzotriazol-2-yl)-4,6-ditertpentylphenol, 2-(2-hydroxy-5-methylphenyl)benzotriazole, 2-[2-hydroxy-3-(3,4,5,6-tetrahydrophthalimide-methyl)-5-methylphenyl]benzotriazole, 2-(2-hydroxy-5-tert-octylphenyl)benzotriazole, 2-(2-Hydroxy-5-tert-butylphenyl)-2H-benzotriazole, methyl3-(3-(2H-benzotriazol-2-yl)-5-tert-butyl-4-hydroxyphenyl)propionate, 2-(2H-benzotriazol-2-yl)-4,6-bis(1-methyl-1-phenylethyl)phenol, 2-(2H-benzotriazol-2-yl)-6-(1-methyl-1-phenylethyl)-4-(1,1,3,3-tetramethylbutyl)phenol, etc.

Specifically, the triazine UV absorber mentioned above may be 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butoxyphenyl)-6-(2,4-bis-butoxyphenyl)-1,3,5-triazine, 2-(2-hydroxy-4-[1-octylcarbonylethoxy]phenyl)-4,6-bis(4-phenylphenyl)-1,3,5-triazine, TINUVIN 477 (trade name, manufactured by Ciba Japan Co., Ltd.), etc.

Organic UV absorbers mentioned above can absorb UV rays in a relatively wide wavelength-range. In the disclosure, one kind of UV absorber can be used alone or in combination with other kinds of UV absorbers, depending on actual needs.

In some embodiments, the blue-light absorber has an absorption peak in a wavelength range of 400 nm˜420 nm, and is selected from a group consisting of an azo blue-light absorber, an isoindolinone blue-light absorber, a quinophthalone blue-light absorber, a benzimidazolone blue-light absorber, and an organic-inorganic composite blue-light absorber. Considering the factors such as the coating uniformity and performance, in some embodiments, a hydroxyl content of the blue-light absorber is greater than or equal to 5% in mass percent.

Specifically, the azo blue-light absorber mentioned above may be azophenylmethacrylate, 2-[(4-methyl-2-nitrophenyl)azo]-3-oxo-N-phenylbutyramide, 2-[(4-chloro-2-nitrophenyl)azo]-N-(2-chlorophenyl)-3-oxobutyramide, JADEWIN 1226 (trade name, manufactured by Qingdao Jade New Material Technology), 2′-(3,3′-dichloro-1,1′-biphenyl-4,4′-bisazo)bis[N-(4-chloro-2,5-dimethoxyphenyl)-3-oxo-butyramide], etc.

Specifically, the isoindolinone blue-light absorber mentioned above may be 1,3,3-trimethyl-2-methyleneindoline, 3,3′-[(2-methyl-1,3-phenylene)diimino]bis[4,5,6,7-tetrachloro-1H-isoindol-1-one], hexachloroisoindolinone, 2-[[3,3-dichloro-4-[[1-[[(2,4-dimethylphenyl)amino]carbonyl]-2-oxopropyl]azo][1,1′-biphenyl]-4-yl]-azo]-N-(2-methylphenyl)-3-oxo-butyramide, etc.

Specifically, the quinophthalone blue-light absorber mentioned above may be 3-(2-cyclopropyl-4-(4-fluorophenyl)-3-quinolinyl)propenal, 3,4,5,6-tetrachloro-N-[2-(4,5,6,7-tetrachloro-2,3-dihydro-1,3-dioxo-1H-inden-2-yl)-8-quinolyl]phthalimide, etc.

Specifically, the benzimidazolone blue-light absorber mentioned above may be 2-(2-hydroxy-5-isoacrylate ethylphenyl)-2H-benzotriazole, 5-[[1-[[(2,3-dihydro-2-oxo-1H-benzimidazol-5-yl)amino]carbonyl]-2-oxopropyl]azo]-1,4-dimethyl terephthalate, dimethyl 2-[[1-[[(2,3-dihydro-2-oxo-1H-benzimidazol-5-yl)amino]carbonyl]-2-oxopropyl]azo]-1,4-dimethyl terephthalate, JADEWIN 1227 (trade name, manufactured by Qingdao Jade New Material Technology), etc.

Specifically, the organic-inorganic composite blue-light absorber mentioned above may be U400 (trade name, manufactured by Shanghai Huzheng Nanotechnology Co., Ltd.), U410 (trade name, manufactured by Shanghai Huzheng Nanotechnology Co., Ltd.), U420 (trade name, manufactured by Shanghai Huzheng Nanotechnology Co., Ltd.), U460 (trade name, manufactured by Shanghai Huzheng Nanotechnology Co., Ltd.), etc.

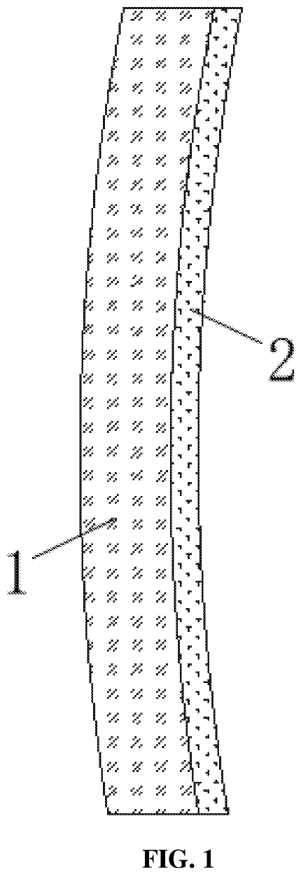

As illustrated in FIG. 1, a glass sheet for blocking UV and blue light is provided in the disclosure. The glass sheet includes a bent glass panel 1, and a coating 2 for blocking UV and blue light. The coating 2 is formed by coating and curing the coating solution for blocking UV and blue light mentioned above on at least one surface of the bent glass panel 1. The coating 2 includes silica, a UV absorber, and a blue-light absorber. The coating 2 has a thickness ranging from 2 μm˜12 μm to meet use requirements of vehicle glass. The coating 2 has a transmittance less than or equal to 5% over a wavelength range of 300 nm˜400 nm, preferably less than or equal to 2%, more preferably less than or equal to 1%, and further preferably less than or equal to 0.5%. The coating 2 has a maximum transmittance less than or equal to 30% over a wavelength range of 400 nm˜440 nm, preferably less than or equal to 20%, more preferably less than or equal to 10%, and most preferably less than or equal to 5%. The glass sheet can block both UV and blue light.

In order to weaken yellowish appearance color of the coating 2, in some embodiments, the coating 2 has a transmittance T460 at a wavelength of 460 nm and a transmittance T410 at a wavelength of 410 nm, where 4≤T460/T410≤60, so as to obtain a good appearance, thereby adapting to more use scenarios. When the bent glass panel 1 is a transparent glass panel, the bent glass panel 1 has a transmittance greater than or equal to 70% over a wavelength range of 400 nm˜800 nm, and in some embodiments, the coating 2 has a transmittance T460 at a wavelength of 460 nm and a transmittance T410 at a wavelength of 410 nm, where 4≤T460/T410≤12. The coating 2 has a transmittance greater than or equal to 70% over a wavelength range of 400 nm˜800 nm, preferably greater than or equal to 80%, more preferably greater than or equal to 85%. Furthermore, in some embodiments, the bent glass panel 1 has a transmittance greater than or equal to 80% over a wavelength range of 400 nm˜800 nm.

In order to meet the use requirements of the vehicle glass, in some embodiments, the coating 2 subjected to a 3000h xenon lamp aging test has a transmittance greater than or equal to 70% over a wavelength range of 400 nm˜800 nm, and the coating 2 subjected to a 1000-revolution abrasion resistance test by a plane abrasion tester has a haze difference that is less than 2%.

The bent glass panel 1 is a physically toughened glass, and is formed by subjecting a flat glass panel to high-temperature heat treatment of at least 560° C. and a bending process. The glass sheet may serve as a side window glass, a rear windshield, etc. of a vehicle.

A method for manufacturing the glass sheet for blocking UV and blue light is further provided in the disclosure, and begins with operations at block 1.

At block 1, mix the following components in mass percent to obtain a mixture: a UV absorber of 1%˜15%, a blue-light absorber of 1%˜15%, a second solvent of 40%˜60%, a second catalyst of 0.01%˜1%, and a second coupling agent of 10%˜30%, and perform refluxing and stirring on the obtained mixture in a constant-temperature oil bath pan at 100° C. to obtain a chelating agent.

In some embodiments, for a sufficient reaction, a duration for performing refluxing and stirring is 2 hours˜8 hours, and a temperature for performing refluxing and stirring is 100° C.˜150° C.

At block 2, mix the following components in mass percent to obtain a mixture: silicate of 15%˜35%, a first solvent of 30%˜60%, a first coupling agent of 5%˜15%, a first catalyst of 0.01%˜1%, and deionized water of 10%˜30%, and stir the mixture in a water bath at 40° C. to obtain a silica sol.

In some embodiments, for a sufficient reaction, a duration for stirring is 60 minutes˜120 minutes.

At block 3, add the chelating agent of 5%˜20% in mass percent to the silica sol, and mix and stir the silica sol with the added chelating agent to obtain a coating solution for blocking UV and blue light.

In some embodiments, for a sufficient reaction, a duration for mixing and stirring is greater than or equal to 120 minutes.

At block 4, coat the coating solution on at least one surface of the bent glass panel 1, and cure the coated coating solution at 80° C.˜120° C. to obtain a glass sheet for blocking UV and blue light with a coating for blocking UV and blue light.

The bent glass panel 1 has a convex and a concave. After the bent glass panel 1 is mounted on a vehicle, the convex faces an outside of the vehicle, and the concave faces an inside of the vehicle. In some embodiments, the coating solution is coated on the concave.

In some embodiments, A duration for curing at 80° C.˜120° C. is 10 minutes˜200 minutes.

Before curing at 80° C.˜120° C., block 4 further includes pre-drying the coating solution coated on the at least one surface of the bent glass panel 1. Pre-drying is performed at a temperature of 20˜60° C., a humidity of 45%˜65%, and for a duration of 20 minutes˜40 minutes, facilitating the subsequent curing.

The coating solution may be coated on the at least one surface of the bent glass panel 1 through a curved surface coating technology such as spray coating, wipe coating, flow coating, brush coating, dip coating, or the like, as well as a composite coating method formed by combining ultrasonic, centrifugal, or rotational techniques.

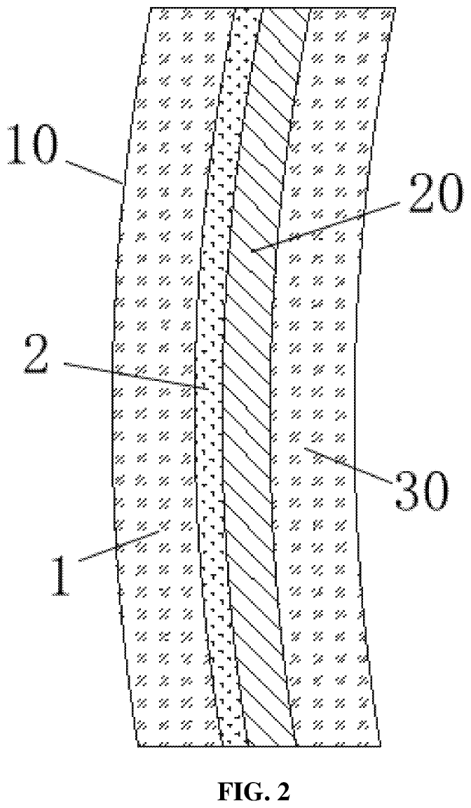

As illustrated in FIG. 2, a laminated glass for blocking UV and blue light is provided in the disclosure. The laminated glass includes a glass sheet 10, an intermediate adhesive layer 20, and a second glass panel 30. The intermediate adhesive layer 20 is sandwiched between the glass sheet 10 and the second glass panel 30. The glass sheet 10 includes the bent glass panel 1 and the coating 2. The coating 2 is disposed on at least one surface of the bent glass panel 1.

The laminated glass may serve as a front windshield, a side window glass, a sunroof glass, or a rear windshield of a vehicle. In some embodiments, After the laminated glass is mounted on a vehicle, the glass sheet 10 serves as an outer glass panel, i.e., the glass sheet 10 is located on an outside surface of the vehicle, and the coating 2 is located between the bent glass panel 1 and the intermediate adhesive layer 20, such that UV radiation on the intermediate adhesive layer 20 can be reduced, and a UV-aging speed of the intermediate adhesive layer 20 can be lowered, and a normal service life of the laminated glass can be prolonged.

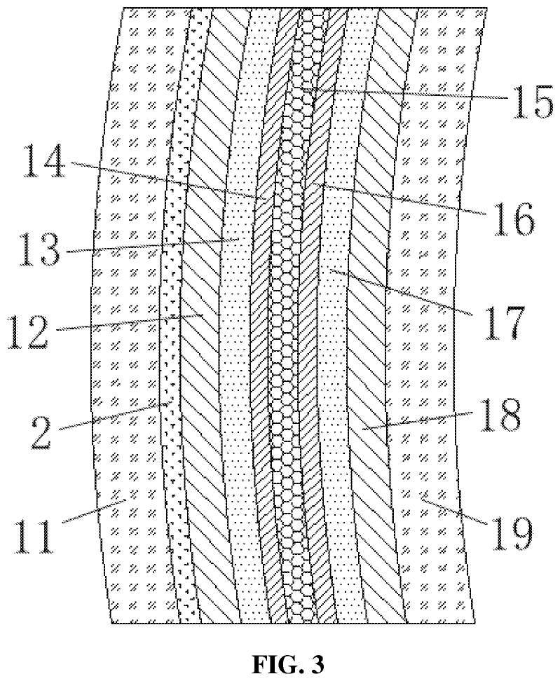

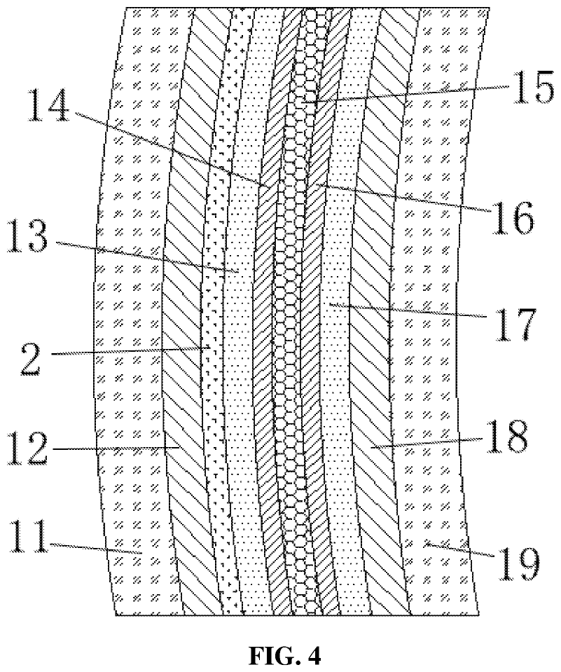

As illustrated in FIG. 3 and FIG. 4, a laminated glass for blocking UV and blue light is provided in the disclosure, and may serve as a sunroof glass capable of dimming. The laminated glass includes a first glass panel 11, a first adhesive layer 12, a first carrier layer 13, a first planar electrode 14, a dimming layer 15, a second planar electrode 16, a second carrier layer 17, a second adhesive layer 18, and a second glass panel 19 that are stacked in sequence, and includes the coating 2. The coating 2 is disposed between the first glass panel 11 and the first carrier layer 13, and/or the coating 2 is disposed between the second glass panel 19 and the second carrier layer 17. The coating 2 can significantly reduce UV rays and blue light entering the vehicle, protecting objects in the vehicle and human eyes, and protecting the dimming layer 15, particularly a PDLC device.

In FIG. 3, the coating 2 is disposed on a surface of the first glass panel 11 and located between the first glass panel 11 and the first adhesive layer 12. The coating 2 is further configured to protect the first adhesive layer 12 from a large amount of UV radiation, and prolong a normal service life of the laminated glass. It can be understood that the coating 2 may also be disposed on a surface of the second glass panel 19 and located between the second glass panel 19 and the second adhesive layer 18. In some embodiments the first glass panel 11 serves as an outer glass panel, i.e., the first glass panel 11 is located on an outside surface of a vehicle, and the coating 2 is configured to block UV and blue light from the outside of the vehicle.

In FIG. 4, the coating 2 is disposed on a surface of the first carrier layer 13 and located between the first carrier layer 13 and the first adhesive layer 12. The coating 2 is configured to block UV and blue light from the outside of the vehicle, so as to protect articles in the vehicle, human eyes, and the dimming layer 15. It can be understood that, the coating 2 may also be disposed on a surface of the second carrier layer 17 and located between the second carrier layer 17 and the second adhesive layer 18.

The dimming layer 15 is configured to adjust a visible-light transmittance of the laminated glass by powering the first planar electrode 14 and the second planar electrode 16. The dimming layer 15 may be a PDLC device, an SPD, or an EC device, so that the laminated glass can meet requirements of sunshade, privacy protection, intelligent energy conservation, and the like.

Each of the first planar electrode 14 and the second planar electrode 16 is a transparent conductive layer, and may specifically include a metal layer, a metal alloy layer, or a metal oxide layer. In an embodiment, a transmittance of each of the first planar electrode 14 and the second planar electrode 16 to visible light is greater than or equal to 70%, preferably greater than or equal to 80%, more preferably greater than or equal to 90%. The metal layer may be made of a material that is selected from Au, Ag, Cu, Al, or Mo. The metal alloy layer may be made of a material that is selected from an Ag alloy, such as an Ag—Cu alloy, an Ag-indium alloy, or the like. The metal oxide layer may be made of a material that is selected from ITO, FTO, AZO, ATO, or the like.

In the disclosure, a laminated glass for blocking UV and blue light and capable of dimming or light emitting is further provided. The laminated glass includes a first glass panel, a first adhesive layer, a dimming structure or a light emitting structure, a second adhesive layer, and a second glass panel that are stacked in sequence. A coating for blocking UV and blue light is disposed between the first glass panel and the dimming structure or between the first glass panel and the light emitting structure, where the coating includes silica, a UV absorber, and a blue-light absorber, the coating has a transmittance less than or equal to 5% over a wavelength range of 300 nm˜400 nm, and the coating has a maximum transmittance less than 20% over a wavelength range of 400 nm˜440 nm; and/or the coating for blocking UV and blue light is disposed between the second glass panel and the dimming structure or between the second glass panel and the light emitting structure, where the coating includes silica, a UV absorber, and a blue-light absorber, the coating has a transmittance less than or equal to 5% over a wavelength range of 300 nm˜400 nm, and the coating has a maximum transmittance less than or equal to 30% over a wavelength range of 400 nm˜440 nm.

In some embodiments, the coating has the transmittance less than or equal to 2% over the wavelength range of 300 nm˜400 nm, and the coating has the maximum transmittance less than or equal to 20% over the wavelength range of 400 nm˜440 nm.

In some embodiments, the coating has the transmittance less than or equal to 1% over the wavelength range of 300 nm˜400 nm, and the coating has the maximum transmittance less than or equal to 10% over the wavelength range of 400 nm˜440 nm.

In some embodiments, the coating has a transmittance T460 at a wavelength of 460 nm and a transmittance T410 at a wavelength of 410 nm, where 4≤T460/T410≤60.

In some embodiments, the coating has a transmittance greater than or equal to 70% over a wavelength range of 400 nm˜800 nm.

In some embodiments, the coating subjected to a 1000-revolution abrasion resistance test by a plane abrasion tester has a haze difference that is less than 2%.

In some embodiments, the coating has a thickness ranging from 2 μm˜12 μm.

In some embodiments, the coating has a transmittance less than 70% over a wavelength range of 400 nm˜800 nm.

In some embodiments, the UV absorber has an absorption peak in a wavelength range of 330 nm˜370 nm, and the blue-light absorber has an absorption peak in a wavelength range of 400 nm˜420 nm.

In some embodiments, the dimming structure is configured to adjust a visible-light transmittance of the laminated glass. The dimming structure is a polymer dispersed liquid crystal (PDLC) device, a suspended particle device (SPD), or an electrochromic (EC) device. The light emitting structure can emit blue light or white light, and the light emitting structure is an organic light-emitting diode (OLED), an inorganic light-emitting diode (LED), an inorganic thin-film electroluminescent element (TFEL), or an organic thin-film electroluminescent element (OTFEL).

In some embodiments, the coating is disposed on a surface of the first glass panel and between the first glass panel and the first adhesive layer, or disposed on a surface of the second glass panel and between the second glass panel and the second adhesive layer.

In some embodiments, the dimming structure includes a first carrier layer, a first planar electrode, a dimming layer, a second planar electrode, and a second carrier layer that are stacked in sequence. The coating is disposed between the first glass panel and the first carrier layer, and/or the coating is disposed between the second glass panel and the second carrier layer.

In some embodiments, the coating is disposed on a surface of the first carrier layer and between the first carrier layer and the first adhesive layer, or disposed on a surface of the second carrier layer and between the second carrier layer and the second adhesive layer.

In some embodiments, each of the first planar electrode and the second planar electrode is a transparent conductive layer. The transparent conductive layer may be a metal layer, a metal alloy layer, or a metal oxide layer, where the metal layer is made of gold (Au), silver (Ag), copper (Cu), aluminum (Al), or molybdenum (Mo), the metal alloy layer is an Ag alloy layer, and the metal oxide layer is made of indium tin oxide (ITO), fluorine-doped tin oxide (FTO), aluminum-doped zinc oxide (AZO), or antimony-doped tin oxide (ATO).

In some embodiments, at least one of the first glass panel, the first adhesive layer, the second adhesive layer, or the second glass panel is colored in bulk.

In some embodiments, at least one of the first glass panel or the second glass panel is a colored glass having a visible-light transmittance less than 70%.

In some embodiments, at least one of the first adhesive layer or the second adhesive layer is a colored adhesive layer having a visible-light transmittance less than or equal to 44%.

The disclosure has the following beneficial effects by means of the technical solutions described above.

In the disclosure, the first carrier layer 13, the first planar electrode 14, the dimming layer 15, the second planar electrode 16, and the second carrier layer 17 are pre-stacked to form a dimming structure. Each of the first carrier layer 13 and the second carrier layer 17 is generally made of polyethylene terephthalate (PET), polyvinyl chloride (PVC), polyvinyl butyral (PVB), ethylene vinyl acetate copolymer (EVA), polyacrylate (PA), or polyurethane (PUR). Each of the first adhesive layer 12 and the second adhesive layer 18 is use to further adhere the dimming structure between the first glass panel 11 and the second glass panel 19 to form the laminated glass. Each of the first adhesive layer 12 and the second adhesive layer 18 is generally be made of PVB, ionic intermediate film (SGP), PVC, EVA, PA, PUR, or the like. In some embodiments, the first adhesive layer 12 and the second adhesive layer 18 can also absorb UV rays, so as to reduce UV rays entering the vehicle. Additionally, since a dimming performance of the dimming layer 15, particularly the PDLC device, is easily affected by UV rays, the first adhesive layer 12 and the second adhesive layer 18 capable of absorbing UV rays are also configured for protecting the dimming layer 15, particularly the PDLC device.

In the disclosure, the dimming structure located between the first adhesive layer 12 and the second adhesive layer 18 can also be replaced with a light emitting structure. The light emitting structure can emit blue light or white light, and for example, the light emitting structure may be an organic light-emitting diode (OLED), an inorganic light-emitting diode (LED), an inorganic thin-film electroluminescent element (TFEL), or an organic thin film electroluminescent element (OTFEL), etc. The coating 2 is disposed on a surface of the first glass panel 11 and located between the first glass panel 11 and the first adhesive layer 12, and the coating 2 is also configured for reducing harmful blue light emitted by the light emitting structure. It can be understood that, the coating 2 may also be disposed on a surface of the second glass panel 19 and located between the second glass panel 19 and the second adhesive layer 18. In some embodiments, the second glass panel 19 serves as an inner glass panel, i.e., the second glass panel 19 is located on an inside surface of the vehicle, and the coating 2 is configured for blocking UV and blue light form an outside of the vehicle and blue light emitted by the light emitting structure, so as to protect human eyes better.

At least one of the first glass panel 11, the first adhesive layer 12, the second adhesive layer 18, or the second glass panel 19 is colored in bulk and has a relatively low visible-light transmittance. At least one of the first glass panel 11 or the second glass panel 19 is a colored glass. For example, a visible-light transmittance of the colored glass such as green glass and grey glass may be less than 70%, less than or equal to 41%, less than or equal to 30%, or less than or equal to 26%. At least one of the first adhesive layer 12 or the second adhesive layer 18 is a colored adhesive layer, and for example, a visible-light transmittance of the colored adhesive layer made of a material such as different types of gray PVB is less than or equal to 44%, 18%, 8%, 5%, or 2%. In this way, privacy can be protected, and a sunshade curtain can be removed when the colored glass serves as a sunroof glass, thereby reducing the product cost and enhancing a space inside a vehicle.

### EMBODIMENTS

Some embodiments of the disclosure are given for further illustration, but the disclosure is not limited to the following embodiments.

### Embodiment 1

A mixing of 10 g of BP-2 UV absorber, 10 g of U410 blue-light absorber, 55 g of butyl acetate solvent, 0.15 g of dibutyltin dilaurate catalyst, and 25 g of γ-Methacryloxypropyltrimethoxysilane is refluxed and stirred in a constant-temperature oil bath pan at 100° C. for 4 hours, and then naturally cooled to a room temperature to obtain chelating agent U1.

A mixing of 13.56 g of tetraethyl orthosilicate, 20 g of absolute ethanol, 30 g of isopropanol, 5.18 g of γ-methacryloxypropyltrimethoxysilane, 0.1 g of nitric acid solution with a mass fraction of 10%, and 12.5 g of deionized water is stirred for 60 minutes in a water bath at 40° C. to obtain silica sol A1.

A mixing of 15 g of silica sol A1 and 1 g of chelating agent U1 is stirred for 120 minutes to obtain coating solution B1 for blocking UV and blue light.

In a dust-free environment, an appropriate amount of coating solution B1 is weighed and coated on a surface of the bent glass panel 1 with a wire bar coater. After being allowed to stand for leveling, coating solution B1 is pre-dried with an infrared lamp, and then further cured at 110° C. for 55 minutes to obtain glass sheet C1 with a coating for blocking UV and blue light.

### Embodiment 2

A mixing of 10 g of BP-2 UV absorber, 10 g of U420 blue-light absorber, 55 g of butyl acetate solvent, 0.15 g of dibutyltin dilaurate catalyst, and 25 g of γ-Methacryloxypropyltrimethoxysilane is refluxed and stirred in a constant-temperature oil bath pan at 100° C. for 4 hours, and then naturally cooled to a room temperature to obtain chelating agent U2.

A mixing of 13.56 g of tetraethyl orthosilicate, 22 g of absolute ethanol, 28 g of isopropanol, 5.18 g of γ-Methacryloxypropyltrimethoxysilane, 0.1 g of nitric acid solution with a mass fraction of 10%, and 12.5 g of deionized water is stirred for 70 minutes in a water bath at 40° C. to obtain silica sol A2.

A mixing of 20 g of silica sol A2 and 1.5 g of chelating agent U2 is stirred for 120 minutes to obtain coating solution B2 for blocking UV and blue light.

In a dust-free environment, an appropriate amount of coating solution B2 is weighed and coated on a surface of the bent glass panel 1 with a wire bar coater. After being allowed to stand for leveling, coating solution B2 is pre-dried with an infrared lamp, and then further cured at 110° C. for 55 minutes to obtain glass sheet C2 with a coating for blocking UV and blue light.

### Embodiment 3

A mixing of 10 g of BP-2 UV absorber, 10 g of JADEWIN 1226 blue-light absorber, 55 g of butyl acetate solvent, 0.15 g of dibutyltin dilaurate catalyst, and 25 g of γ-Methacryloxypropyltrimethoxysilane is refluxed and stirred in a constant-temperature oil bath pan at 100° C. for 4 hours, and then naturally cooled to a room temperature to obtain chelating agent U3.

A mixing of 13.56 g of tetraethyl orthosilicate, 25 g of absolute ethanol, 28 g of isopropanol, 5.18 g of γ-Methacryloxypropyltrimethoxysilane, 0.1 g of nitric acid solution with a mass fraction of 10%, and 12.5 g of deionized water is stirred for 80 minutes in a water bath at 40° C. to obtain silica sol A3.

A mixing of 20 g of silica sol A3 and 1.3 g of chelating agent U3 is stirred for 120 minutes to obtain coating solution B3 for blocking UV and blue light.

In a dust-free environment, an appropriate amount of coating solution B3 is weighed and coated on a surface of the bent glass panel 1 with a wire bar coater. After being allowed to stand for leveling, coating solution B3 is pre-dried with an infrared lamp, and then further cured at 110° C. for 55 minutes to obtain glass sheet C3 with a coating for blocking UV and blue light.

### Embodiment 4

A mixing of 10 g of silica sol A1 and 1 g of chelating agent U1 is stirred for 120 minutes an obtained mixture to obtain coating solution B4 for blocking UV and blue light.

In a dust-free environment, an appropriate amount of coating solution B4 is weighed and coated on a surface of the bent glass panel 1 with a wire bar coater. After being allowed to stand for leveling, coating solution B4 is pre-dried with an infrared lamp, and then further cured at 110° C. for 55 minutes to obtain glass sheet C4 with a coating for blocking UV and blue light.

### Embodiment 5

A mixing of 10 g of silica sol A1 and 1.5 g of chelating agent U1 is stirred for 120 minutes to obtain coating solution B5 for blocking UV and blue light.

In a dust-free environment, an appropriate amount of coating solution B5 is weighed and coated on a surface of the bent glass panel 1 with a wire bar coater. After being allowed to stand for leveling, coating solution B5 is pre-dried with an infrared lamp, and then further cured at 110° C. for 55 minutes to obtain glass sheet C5 with a coating for blocking UV and blue light.

### Comparative Embodiment 1

In a dust-free environment, an appropriate amount of silica sol A1 is weighed and coated on a surface of the bent glass panel 1 with a wire bar coater. After being allowed to stand for leveling, silica sol A1 is pre-dried with an infrared lamp, and further then cured at 110° C. for 55 minutes to obtain comparative glass sheet D1.

### Comparative Embodiment 2

A mixing of 10 g of silica sol A1 and 3 g of chelating agent U1 is stirred for 120 minutes to obtain coating solution B6 for blocking UV and blue light.

In a dust-free environment, an appropriate amount of coating solution B6 is weighed and coated on a surface of the bent glass panel 1 with a wire bar coater. After being allowed to stand for leveling, coating solution B6 is pre-dried with an infrared lamp, and then further cured at 110° C. for 55 minutes to obtain glass sheet D2 with a coating for blocking UV and blue light is obtained.

Evaluation

Glass sheet samples obtained in embodiments 1 to 5 and comparative embodiments 1 and 2 are evaluated by the following test, and an evaluation result is illustrated in Table 1.

Transmittance: a transmittance spectrum over a wavelength range of 250 nm˜2550 nm is measured by using a spectrophotometer. A UV transmittance over a wavelength range of 300 nm˜400 nm and a visible-light transmittance over a wavelength range of 400 nm˜800 nm are calculated according to ISO 13837 standard, and a maximum blue-light transmittance over a wavelength range of 400 nm˜440 nm is obtained according to the transmittance spectrogram. The transmittance in the disclosure refers to an average value that is obtained by measuring five different points on the same glass-sheet sample.

Coating thickness: The coating thickness is measured by a step gauge.

Aging resistance: in an aging resistance test, a sample is putted into a xenon lamp aging tester (model: CI4000 U.S.) with calibrated lamp tubes, where a rainfall cycle is set to consist of drying time of 102 minutes and rainfall time of 18 minutes, an irradiance is set to be 60±2 w/m² with a wavelength of 300 nm˜400 nm, test time is set to be 3000 hours, a black panel temperature is set to be 65±3° C., and a relative humidity is set to be 50±10%. The sample after the aging resistance test is observed to determine that whether there is a crack on an appearance of the coating.

Abrasion resistance: the abrasion resistance is measured by a plane abrasion tester. A glass sample is placed on the plane abrasion tester with a coating facing upward and subjected to 1000-revolution plane abrasion resistance test.

Haze: a hazemeter is used to test a sample after the abrasion resistance test. Haze1 is obtained by testing a region that has not undergone the abrasion resistance test. Haze2 is obtained by moving the sample and testing a region that has undergone the abrasion resistance test. A haze difference before and after abrasion resistance test is |Haze2−Haze1|.

TABLE 1
evaluation result of comparative embodiments 1 and 2 and embodiments 1 to 5

| | Comparative | Comparative | Embodiment | Embodiment | Embodiment | Embodiment | Embodiment |
|---|---|---|---|---|---|---|---|
| Evaluation items | embodiment 1 | embodiment 2 | 1 | 2 | 3 | 4 | 5 |
| Coating thickness | 5.1 μm | 4.9 μm | 5.3 μm | 4.8 μm | 5.4 μm | 5.2 μm | 5.1 μm |
| UV transmittance | 49.77% | 0.02% | 0.01% | 0.03% | 0.01% | 0.01% | 0.01% |
| for 300 nm~400 | | | | | | | |
| nm | | | | | | | |
| Maximum blue- | 78.52% | 0.97% | 9.78% | 4.55% | 11.75% | 3.22% | 1.17% |
| light | | | | | | | |
| transmittance for | | | | | | | |
| 400 nm~440 nm | | | | | | | |
| Visible-light | 80.51% | 60.58% | 72.15% | 70.88% | 71.74% | 66.42% | 63.41% |
| transmittance for | | | | | | | |
| 400 nm~800 nm | | | | | | | |
| Aging resistance | qualified | qualified | qualified | qualified | qualified | qualified | qualified |
| Haze difference | 1.2% | 2.4% | 1.3% | 1.1% | 1.5% | 1.3% | 1.6% |
| before and after | | | | | | | |
| abrasion | | | | | | | |
| resistance test | | | | | | | |

The following can be seen from Table 1.

In comparative embodiment 1, a silica sol coating is formed on the bent glass panel. Though the silica sol coating satisfies the requirements of aging resistance and abrasion resistance, the silica sol coating cannot block the UV and blue light.

In comparative embodiment 2, the coating for blocking UV and blue light is formed on the bent glass panel. However, an excessive amount (such as 30%) of the chelating agent is added to the silicon sol. Although the UV transmittance and the maximum blue-light transmittance of the coating can satisfy requirements and are low, the coating does not satisfy abrasion resistance requirements, and thus the coating cannot serve as a vehicle glass.

In embodiments 1 to 3, the coating for blocking UV and blue light is formed on the bent glass panel. By adding an appropriate amount of the chelating agent to the silicon sol, not only the UV transmittance, the maximum blue-light transmittance, and the visible-light transmittance satisfy requirements, but also both the aging resistance and the abrasion resistance satisfy requirements.

In embodiments 4 and 5, the coating for blocking UV and blue light is formed on the bent glass panel, and an appropriate amount of the chelating agent is added to the silica sol, where more chelating agent is added in embodiments 4 and 5 than embodiments 1 to 3. In embodiments 4 and 5, the UV transmittance satisfies requirements, both the aging resistance and the abrasion resistance also satisfy requirements, the maximum blue-light transmittance is less than that in embodiments 1 to 3, but the visible-light transmittance is less than 70%. Therefore, the glass sheet in embodiments 4 and 5 can be coated to a portion of a vehicle where there is no requirement for visible-light transmittance or where the allowed visible-light transmittance is less than 70%. For example, the glass sheet can serve as a sunroof glass, and in particular a sunroof glass without a sunshade curtain, a dimming sunroof glass, or a light-emitting sunroof glass, etc.

According to the coating solution, the glass sheet, and the method for manufacturing the glass sheet described in the disclosure, both the UV transmittance and the blue-light transmittance can be reduced, such that requirements for blocking both UV and blue light can be satisfied. The coating can also have excellent properties such as aging resistance and abrasion resistance, such that a normal service life of the substrate can be prolonged. Additionally, the coating solution has a very low volatile organic compound (VOC) emission, which is environmentally friendly and easy to coat. The coating can also comply with regulations of vehicle glass. The coating solution, the glass sheet, and the method for manufacturing the glass sheet can be coated to the laminated glass for blocking UV and blue light provided with the dimming structure or the light emitting structure. This enables the laminated glass to block UV and blue light from outside a vehicle, thereby prolonging a normal service life of the dimming structure or the light emitting structure, protecting the dimming structure, blocking blue light emitted by the light emitting structure, providing better protection for human eyes, and achieving sun shading, privacy protection, intelligent energy conservation and the like.

The coating solution for blocking UV and blue light, the glass sheet for blocking UV and blue light and the method for manufacturing the glass sheet, and the laminated glass for blocking UV and blue light and capable of dimming or light emitting are elaborated above, but the disclosure is not limited to the embodiments described above. Any improvements, equivalent modifications, and replacements made according to technical points of the disclosure fall into the protection scope of the disclosure.

What is claimed is:

1. A coating solution for blocking ultraviolet (UV) and blue light, configured to form a coating for blocking UV and blue light on a surface of a substrate, and comprising a silica sol and a chelating agent, wherein
the silica sol comprises, in mass percent, silicate of 15%˜35%, a first solvent of 30%˜60%, a first coupling agent of 5%˜15%, a first catalyst of 0.01%˜1%, and deionized water of 10%˜30%; and
the chelating agent comprises, in mass percent, a UV absorber of 1%˜15%, a blue-light absorber of 1%˜15%, a second solvent of 40%˜60%, a second catalyst of 0.01%˜1%, and a second coupling agent of 10%˜30%.

2. The coating solution of claim 1, wherein the silica sol is added with the chelating agent of 5%˜20% in mass percent.

3. The coating solution of claim 1, wherein the silicate is at least one of tetramethyl orthosilicate, tetraethyl orthosilicate, trimethoxysilane, triethoxysilane, or dimethyldimethoxysilane.

4. The coating solution of claim 1, wherein each of the first coupling agent and the second coupling agent is at least one of 3-Aminopropyltrimethoxysilane, γ-Aminopropyltriethoxysilane, γ-(2,3-Epoxypropoxy)propyltrimethoxysilane, γ-Methacryloxypropyltrimethoxysilane, or N-(β-Aminoethyl)-γ-aminopropyltrimethoxysilane.

5. The coating solution of claim 1, wherein the first solvent is at least one of methanol, ethanol, propanol, isopropanol, butanol, or propylene glycol methyl ether, and the second solvent is at least one of butyl acetate, propylene glycol methyl ether, isobutyl acetate, or xylene.

6. The coating solution of claim 1, wherein the first catalyst is at least one of hydrochloric acid, nitric acid, or ammonia solution, and the second catalyst is at least one of dibutyltin dilaurate, an organobismuth catalyst, or stannous octoate.

7. The coating solution of claim 1, wherein the UV absorber has an absorption peak in a wavelength range of 330 nm˜370 nm, and the blue-light absorber has an absorption peak in a wavelength range of 400 nm˜420 nm.

8. The coating solution of claim 1, wherein a hydroxyl content of the UV absorber is greater than or equal to 5% in mass percent, and the UV absorber is at least one of a benzophenone UV absorber, a benzimidazole UV absorber, or a triazine UV absorber.

9. The coating solution of claim 1, wherein a hydroxyl content of the blue-light absorber is greater than or equal to 5% in mass percent, and the blue-light absorber is at least one of an azo blue-light absorber, an isoindolinone blue-light absorber, a quinophthalone blue-light absorber, a benzimidazolone blue-light absorber, or an organic-inorganic composite blue-light absorber.

10. A glass sheet for blocking ultraviolet (UV) and blue light, comprising a bent glass panel and a coating for blocking UV and blue light, the coating being disposed on at least one surface of the bent glass panel, wherein the coating comprises silica, a UV absorber, and a blue-light absorber, the coating has a thickness ranging from 2 μm˜12 μm, the coating has a transmittance less than or equal to 5% over a wavelength range of 300 nm˜400 nm, and the coating has a maximum transmittance less than 30% over a wavelength range of 400 nm˜440 nm.

11. The glass sheet of claim 10, wherein the coating has the transmittance less than or equal to 2% over the wavelength range of 300 nm˜400 nm, and the coating has the maximum transmittance less than or equal to 20% over the wavelength range of 400 nm˜440 nm.

12. The glass sheet of claim 10, wherein the coating has the transmittance less than or equal to 1% over the wavelength range of 300 nm˜400 nm, and the coating has the maximum transmittance less than or equal to 10% over the wavelength range of 400 nm˜440 nm.

13. The glass sheet of claim 10, wherein the coating has a transmittance T460 at a wavelength of 460 nm and a transmittance T410 at a wavelength of 410 nm, wherein 4≤T460/T410≤60.

14. The glass sheet of claim 10, wherein the coating has a transmittance T460 at a wavelength of 460 nm and a transmittance T410 at a wavelength of 410 nm, wherein 4≤T460/T410≤12.

15. The glass sheet of claim 10, wherein the bent glass panel has a transmittance greater than or equal to 70% over a wavelength range of 400 nm˜800 nm.

16. The glass sheet of claim 10, wherein the coating has a transmittance greater than or equal to 70% over a wavelength range of 400 nm˜800 nm.

17. The glass sheet of claim 10, wherein the coating subjected to a 3000h xenon lamp aging test has a transmittance greater than or equal to 70% over a wavelength range of 400 nm˜800 nm, and wherein the coating subjected to a 1000-revolution abrasion resistance test by a plane abrasion tester has a haze difference that is less than 2%.

18. The glass sheet of claim 10, wherein the bent glass panel is formed by subjecting a flat glass panel to high-temperature heat treatment of at least 560° C. and a bending process.

19. A laminated glass for blocking ultraviolet (UV) and blue light, comprising the glass sheet of claim 10, an intermediate adhesive layer, and a second glass panel, wherein the intermediate adhesive layer is sandwiched between the glass sheet and the second glass panel, the glass sheet comprises the bent glass panel and the coating, the coating is disposed on at least one surface of the bent glass panel, and the coating is located between the bent glass panel and the intermediate adhesive layer.

20. A laminated glass for blocking ultraviolet (UV) and blue light and capable of dimming or light emitting, comprising a first glass panel, a first adhesive layer, a dimming structure or a light emitting structure, a second adhesive layer, and a second glass panel that are stacked in sequence, wherein
a coating for blocking UV and blue light is disposed between the first glass panel and the dimming structure or between the first glass panel and the light emitting structure, wherein the coating comprises silica, a UV absorber, and a blue-light absorber, the coating has a transmittance less than or equal to 5% over a wavelength range of 300 nm˜400 nm, and the coating has a maximum transmittance less than 30% over a wavelength range of 400 nm˜440 nm; and/or
the coating is disposed between the second glass panel and the dimming structure or between the second glass panel and the light emitting structure, wherein the coating comprises silica, a UV absorber, and a blue-light absorber, the coating has a transmittance less than or equal to 5% over a wavelength range of 300 nm˜400 nm, and the coating has a maximum transmittance less than 30% over a wavelength range of 400 nm˜440 nm.
